(19) United States
(12) Patent Application Publication
(10) Pub. No.: US 2006/0209169 A1
(43) Pub. Date: Sep. 21, 2006

(54) Light scanning unit and electrophotographic image forming apparatus having the same

(76) Inventor: Jae-hwan Yoo, Yongin-si (KR)

Correspondence Address: STANZIONE & KIM, LLP, 919 18TH STREET, N.W., SUITE 440, WASHINGTON, DC, 20006, US

(21) Appl. No.: 11/359,412

(22) Filed: Feb. 23, 2006

(30) Foreign Application Priority Data
Mar. 17, 2005 (KR) 2005-22188

(51) Int. Cl. B41J 15/14

(52) U.S. Cl. 347/243

(57) ABSTRACT

A light scanning unit that scans light that corresponds to image information and an electrophotographic image forming apparatus having the same. The light scanning unit includes a housing in which a transparent window is formed, a light scanning portion disposed inside the housing to scan light to an outside of the housing through the transparent window, and a reflection mirror disposed outside the housing to reflect the scanned light to be directed to a photosensitive drum.

### CROSS-REFERENCE TO RELATED APPLICATIONS

This application claims the benefit of Korean Patent Application No. 2005-22188, filed on Mar. 17, 2005, in the Korean Intellectual Property Office, the disclosure of which is incorporated herein in its entirety by reference.

### BACKGROUND OF THE INVENTION

1. Field of the Invention

The present general inventive concept relates to an electrophotographic image forming apparatus, and more particularly, to an electrophotographic image forming apparatus having a light scanning unit that forms an electrostatic latent image on a photosensitive medium by scanning light that corresponds to image information to the photosensitive medium.

2. Description of the Related Art

In general, a light scanning unit such as a laser scanning unit is used in an image forming apparatus that prints an image on paper, such as a copying machine or a laser printer. The light scanning unit forms an electrostatic latent image by scanning light emitted from a light source onto a photosensitive medium of the image forming apparatus.

FIG. 1 is an exploded perspective view illustrating a conventional light scanning unit 10. Referring to FIG. 1, the light scanning unit 10 includes a housing having a base 11 and a cover 13, and a light scanning portion installed inside the housing. The light scanning portion includes a light source 15 that emits light, an optical deflector 20 that deflects light so that light emitted from the light source 15 is scanned onto a photosensitive medium (not shown), and an f-θ lens 25 that corrects aberration of the light deflected by the optical deflector 20. The light scanning unit 10 further includes a collimating lens 17 that collimates the light emitted from the light source 15, and a cylinder lens 18 that shapes the collimated light linearly.

In addition, a reflection mirror 30 is fixedly installed inside the housing to reflect the light passing through the f-θ lens 25 to be directed to the photosensitive medium. Scanned light that corresponds to image information is reflected by the reflection mirror 30, is transmitted through a transparent window 12 formed on the base 11, and is emitted toward the photosensitive medium.

The light scanning components 15, 17, 20, and 25 installed inside the housing are typically used in most light scanning units. However, since a position of the photosensitive medium, which is an object to be exposed, may vary in different types of image forming apparatuses, a number and an installation position of the reflection mirror 30 in the housing may vary, and a position of the housing at which the transparent window 12 is to be formed may also vary. As such, the light scanning unit 10 cannot be commonly used in different types of image forming apparatuses, causing an increase in manufacturing costs of the light scanning unit 10 and the different types of image forming apparatuses.

### SUMMARY OF THE INVENTION

The present general inventive concept provides a light scanning unit and a reflection mirror disposed outside a housing of the light scanning unit, and an electrophotographic image forming apparatus having the same.

Additional aspects of the present general inventive concept will be set forth in part in the description which follows and, in part, will be obvious from the description, or may be learned by practice of the general inventive concept.

The foregoing and/or other aspects of the present general inventive concept may be achieved by providing a light scanning unit, including a housing in which a transparent window is formed, a light scanning portion disposed inside the housing to scan light to an outside of the housing through the transparent window, and a reflection mirror disposed outside the housing to reflect the scanned light to an object to be exposed.

The reflection mirror may include a transparent board layer that extends along a main scanning direction of the scanned light, and a reflection layer coated on a rear surface of the board layer to reflect the scanned light, wherein the scanned light is transmitted through the board layer to be reflected by the reflection layer toward the object to be exposed.

Alternatively, the reflection mirror may include a board layer that extends along a main scanning direction of the scanned light, a reflection layer coated on a front surface of the board layer so that the scanned light is not transmitted through the board layer and is reflected toward the object to be exposed, and a transparent shield that covers an entire surface of the reflection layer so as to protect the reflection layer.

The light scanning unit may further include a frame that is attachable to and removable from the housing to form an internal space that is isolated from the outside when the frame is attached to the housing, wherein the reflection mirror is installed in the internal space formed by the frame.

The foregoing and/or other aspects of the present general inventive concept may also be achieved by providing a light scanning unit usable in an electrophotographic image forming apparatus, comprising a housing having an opening, a light source disposed in the housing to emit light, and an optical deflector disposed in the housing to deflect the emitted light through the opening along a predetermined plane.

The foregoing and/or other aspects of the present general inventive concept may also be achieved by providing a light scanning unit, comprising a housing having a bottom surface, a top surface, and a plurality of side surfaces, a light scanning portion disposed in the housing to scan light, and a transparent window disposed in one of the plurality of side surfaces to transmit the scanned light outside the housing.

The foregoing and/or other aspects of the present general inventive concept may also be achieved by providing an electrophotographic image forming apparatus, comprising a case, a photosensitive medium disposed in the case on which an electrostatic latent image is formed, and a light scanning unit disposed in the case to emit light to form the electrostatic latent image on the photosensitive medium. The light scanning unit includes a housing having an opening, a light source disposed in the housing to emit light, and an optical deflector disposed in the housing to deflect the emitted light through the opening along a predetermined plane.

The foregoing and/or other aspects of the present general inventive concept may also be achieved by providing an electrophotographic image forming apparatus, including a photosensitive drum having an outer circumference on which an electrostatic latent image is formed, a light scanning unit to scan light that corresponds to image information to the photosensitive drum. The light scanning unit includes a housing in which a transparent window is formed, a light scanning portion disposed inside the housing to scan light to an outside of the housing through the transparent window, and a reflection mirror disposed outside the housing to reflect the scanned light toward the photosensitive drum.

### BRIEF DESCRIPTION OF THE DRAWINGS

These and/or other aspects of the present general inventive concept will become apparent and more readily appreciated from the following description of the embodiments, taken in conjunction with the accompanying drawings of which:

FIG. 1 is an exploded perspective view illustrating a conventional light scanning unit;

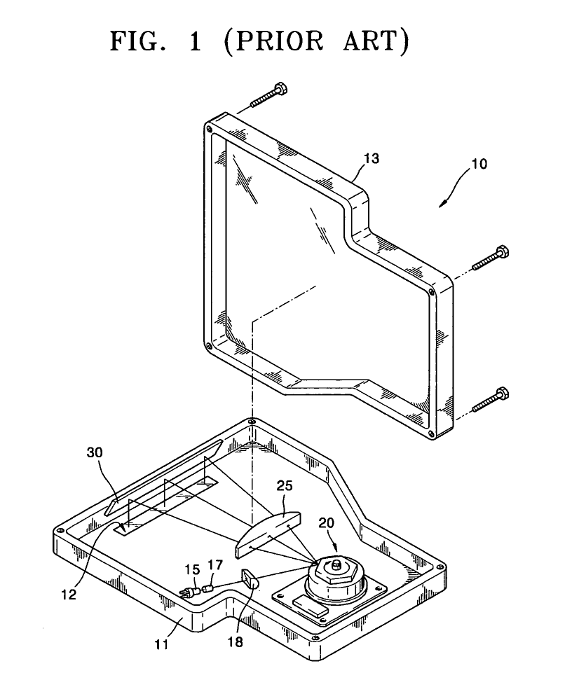

FIG. 2 is a cross-sectional view illustrating an electrophotographic image forming apparatus according to an embodiment of the present general inventive concept;

FIG. 3 is an exploded perspective view illustrating a light scanning unit of the electrophotographic image forming apparatus of FIG. 2 according to an embodiment of the present general inventive concept; and

FIGS. 4 and 5 are cross-sectional views illustrating light scanning units according to other embodiments of the present general inventive concept.

### DETAILED DESCRIPTION OF THE PREFERRED EMBODIMENTS

Reference will now be made in detail to the embodiments of the present general inventive concept, examples of which are illustrated in the accompanying drawings, wherein like reference numerals refer to the like elements throughout. The embodiments are described below in order to explain the present general inventive concept by referring to the figures.

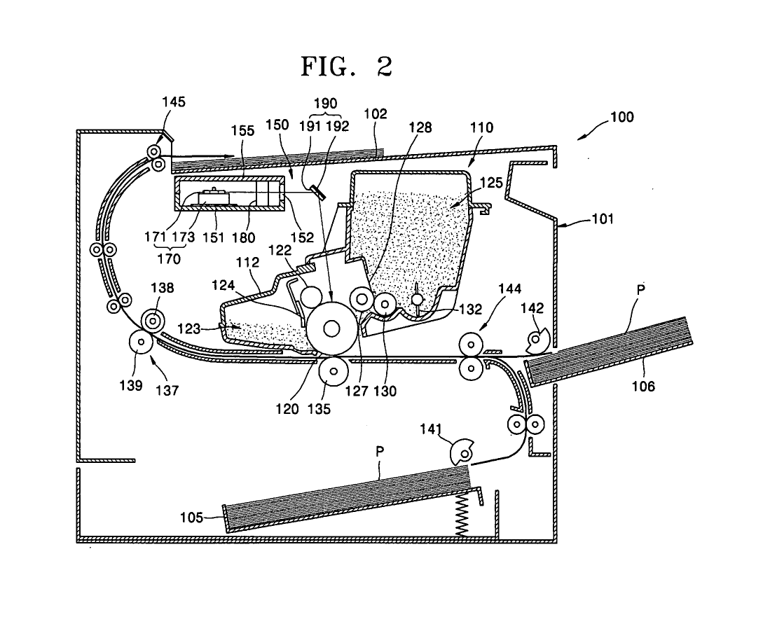

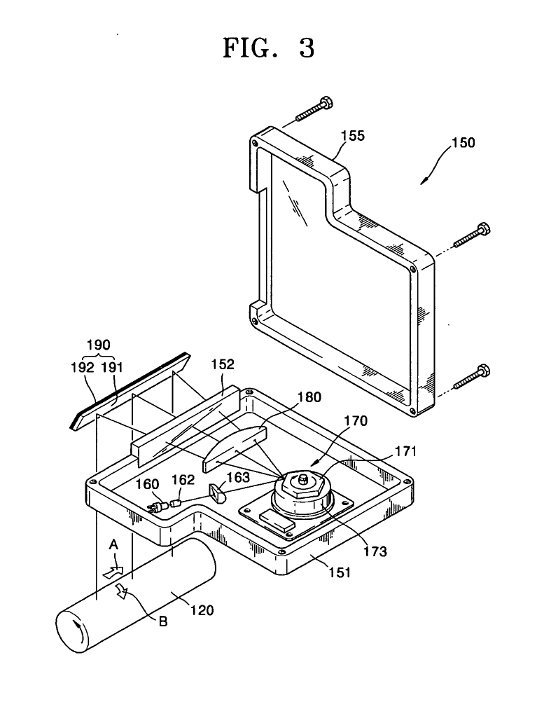

FIG. 2 is a cross-sectional view illustrating an electrophotographic image forming apparatus 100 according to an embodiment of the present general inventive concept, and FIG. 3 is an exploded perspective view illustrating a light scanning unit 150 of the electrophotographic image forming apparatus 100 of FIG. 2.

Referring to FIG. 2, the electrophotographic image forming apparatus 100 includes a case 101, the light scanning unit 150, and a developing unit 110 disposed inside the case 101.

A photosensitive medium 120 (e.g., a photosensitive drum) is configured by forming a photoconductive material layer on an outer circumference of a cylindrical drum using deposition or other fabrication processes. The photosensitive medium 120 is charged to a predetermined potential using a charging roller 122, and an electrostatic latent image created by light scanned by the light scanning unit 150 that corresponds to an image to be printed is formed on an outer circumference of the photosensitive medium 120. The electrophotographic image forming apparatus 100 further includes a first paper feed cassette 105 having a recording medium P stacked therein, a second paper feed cassette 106 having the recording medium P stacked therein, and first and second pickup rollers 141 and 142 to pickup the recording medium P from the first and second paper feed cassettes 105 and 106, respectively. The electrophotographic image forming apparatus 100 further includes a feeding unit 144 to feed the recording medium P along a transfer path, a transfer roller 135 opposite the photosensitive medium 120 to transfer a toner image to the recording medium P, and a fusing unit 137 to fuse the toner image on the recording medium P, and a discharging unit 145. The fusing unit 137 includes a pressure roller 139 and a heat roller 138. The developing unit 110 includes a toner storage 125 having an agitator 132 disposed therein to agitate the toner, a supply roller 130 to supply toner, a developing roller 127 to receive the toner from the supply roller 130 and to supply the toner to the photosensitive medium 120, a waster toner storage 123 having a cover 112, and a cleaning unit 124 to remove excess toner from the photosensitive medium 120. The developing unit 110 further includes a film seal 128 to prevent toner from leaking from the toner storage 125.

Referring to FIGS. 2 and 3, the light scanning unit 150 includes a housing that forms an internal space by combining a base 151 and a cover 155, a light scanning portion installed inside the housing, and a reflection mirror 190 disposed outside the housing. The light scanning portion includes a light source 160, an optical deflector 170, and an f-θ lens 180.

The light source 160 is modulated to selectively scan light on a portion of the photosensitive medium 120, which is an object to be exposed, to form the electrostatic latent image. A controller (not shown) may be used to control the light source 160. For example, a laser diode may be used as the light source 160.

Referring to FIG. 3, the optical deflector 170 deflects and scans the light emitted from the light source 160 along a main scanning direction indicated by arrow A. The optical deflector 170 includes a driving source 173 and a polygon mirror 171 installed to be rotated by the driving source 173. The polygon mirror 171 includes a plurality of reflective surfaces to deflect and scan incident light from the light source 160 while rotating.

The f-θ lens 180 is disposed in an optical path formed between the optical deflector 170 and the photosensitive medium 120. The f-θ lens 180 corrects the light deflected and scanned by the optical deflector 170 with different magnifications along the main scanning direction indicated by the arrow A and in a subsidiary scanning direction indicated by arrow B, respectively, so as to form the electrostatic latent image on the photosensitive medium 120. The subsidiary scanning direction B is opposite to a rotational direction of the photosensitive medium 120, and the main scanning direction A is an axial direction of the photosensitive medium 120. FIG. 3 illustrates that the f-θ lens 180 can be formed of one lens, however, the f-θ lens 180 may alternatively be formed of a plurality of lenses. Scanned light that has been corrected by the f-θ lens 180 is transmitted through a transparent window 152 disposed at a sidewall of the housing and is emitted to an outside of the housing.

The light scanning unit 150 further includes a collimating lens 162 and a cylinder lens 163 disposed in an optical path between the light source 160 and the optical deflector 170. The collimating lens 162 collimates light emitted by the light source 160. The cylinder lens 163 focuses the light collimated by the collimating lens 162 in the main scanning direction A and in the subsidiary scanning direction B, respectively, so as to form an image on the optical deflector 170. A synchronous signal detecting unit (not shown) that detects a synchronous signal for horizontal synchronization using a part of light deflected from the optical deflector 170 may be disposed inside the housing.

The reflection mirror 190 reflects the scanned light emitted from the transparent window 152 to be directed to the photosensitive medium 120. The reflection mirror 190 is fixedly installed inside the case 101. The reflection mirror 190 includes a board layer 191 that extends along the main scanning direction A, and a reflection layer 192 coated on a rear surface of the board layer 191. The board layer 191 may be formed of transparent glass or transparent polymer resin so that scanned light can be transmitted therethrough . The reflection layer 192 may be formed by coating a photo-reflection material such as SiO2 on the board layer 191.

The light emitted from the light source 160 sequentially passes through the collimating lens 162 and the cylinder lens 163 and is deflected and scanned by the polygon mirror 171 of the optical deflector 170. The scanned light is corrected by the f-θ lens 180 and is emitted to the reflection mirror 190 through the transparent window 152. Referring to FIG. 3, the scanned light incident on the reflection mirror 190 is transmitted through the transparent board layer 191, is reflected by the reflection layer 192, and is transmitted back through the board layer 191 to be emitted to the photosensitive medium 120 from a front surface of the board layer 191.

Since the reflection mirror 190 is disposed outside the housing having the base 151 and the cover 155, the reflection mirror 190 may be damaged by dust. Thus, a user can eliminate contaminant by cleaning the front surface of the board layer 191 using a cleaner, such as cotton flannel. Alternatively, a cleaning unit that cleans the reflection mirror 190 automatically may be disposed in the case 101.

Since the reflection layer 192 of the reflection mirror 190 is disposed at the rear surface of the board layer 191, even when a front surface of the board layer 191 is cleaned using the cleaner, the reflection layer 192 may not be damaged. Thus, printing quality is not degraded by damage to the reflection layer 192 of the reflection mirror 190.

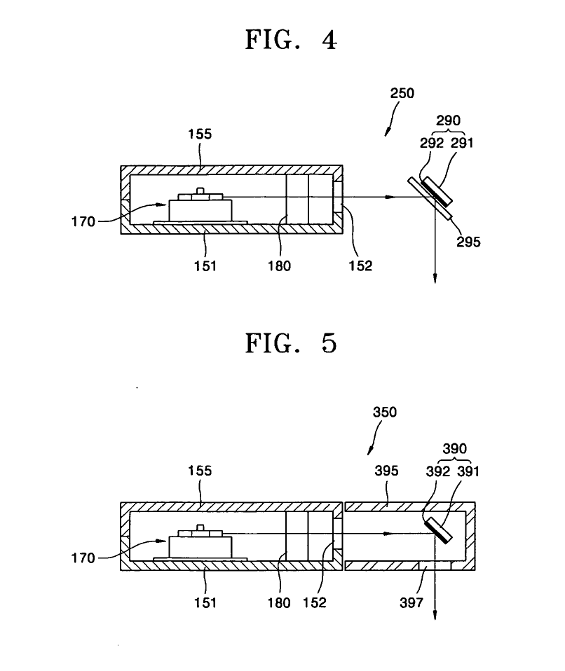

FIGS. 4 and 5 are cross-sectional views of light scanning units (250 and 350) according to other embodiments of the present general inventive concept. Both the light scanning unit 250 illustrated in FIG. 4 and the light scanning unit 350 illustrated in FIG. 5 include a similar housing and light scanning portion installed in the housing as the light scanning unit 150 illustrated in FIG. 2. Thus, a description of the housing including the base 151, the cover 155, and the transparent window 152 will not be provided here.

Referring to FIG. 4, the light scanning unit 250 includes a reflection mirror 290 disposed outside the housing, which includes the base 151 and the cover 155, and reflects scanned light emitted from the transparent window 152 to be directed to a photosensitive medium (similar to 120 of FIG. 2). The reflection mirror 290 includes a board layer 291 that extends along a main scanning direction (similar to A of FIG. 3) and a reflection layer 292 coated on a front surface of the board layer 291 so that the scanned light cannot be transmitted by the board layer 291 and can be reflected toward the photosensitive medium 120 by the reflection layer 292. The board layer 291 does not need to be formed of a transparent material. The reflection layer 292 may be formed by coating a photo-reflection material such as SiO2 on the board layer 291. The reflection mirror 290 includes a shield 295 that protects the reflection layer 292 by covering an entire surface of the reflection layer 292. The shield 295 may be formed of transparent glass or transparent polymer resin so that scanned light can be transmitted thereby to and from the reflection layer 292. The reflection mirror 290 may be supported on the case 101 (see FIG. 2) via the board layer 291.

The scanned light emitted through the transparent window 152 is transmitted through the shield 295, is reflected by the reflection layer 292, is transmitted back through the shield 295, and is emitted to the photosensitive medium 120. Since the entire surface of the reflection mirror 290 is covered by the shield 295, contamination of the reflection layer 292 caused by dust can be prevented and damage to the reflection layer 292 that may occur as a result of carelessness can also be prevented. The shield 295 can be cleaned using a cleaner such as cotton flannel in order to prevent printing quality from being degraded by an exposure defect.

Referring to FIG. 5, the light scanning unit 350 includes a frame 395 that is attachable to and removable from the housing, which includes the base 151 and the cover 155, and forms an internal space isolated from the outside when the frame 395 is attached to the housing, and a reflection mirror 390 is fixedly installed inside the frame 395. A transparent window 397 is disposed in the frame 395 to transmit the scanned light reflected from the reflection mirror 390 that is directed to a photosensitive medium (similar to 120 of FIG. 2). The reflection mirror 390 includes a board layer 391 that extends along a main scanning direction (similar to A of FIG. 3) and a reflection layer 392 coated on a front surface of the board layer 391 so that the scanned light cannot be transmitted to the board layer 391 and can be reflected by the reflection layer 392 toward the photosensitive medium 120. The board layer 391 does not need to be formed of a transparent material. The reflection layer 392 may be formed by coating a photo-reflection material such as SiO2 on the board layer 391.

The scanned light emitted through the transparent window 152 of the housing is reflected by the reflection layer 392 formed on an entire surface of the reflection mirror 390 inside the frame 395, is transmitted through the transparent window 397 of the frame 395, and is emitted to the photosensitive medium 120. Since the reflection mirror 390 is isolated from the outside by the frame 395, contamination of the reflection mirror 390 caused by dust can be prevented and damage that may occur as a result of carelessness can be prevented.

As described above, in a light scanning unit and an electrophotographic image forming apparatus having the same according to the various embodiments of the present general inventive concept, a housing and a light scanning portion installed inside the housing do not need to be changed according to different types of image forming apparatuses. That is, the housing and the light scanning portion can be commonly used in a variety of different types of image forming apparatus. Thus, manufacturing costs of the electrophotographic image forming apparatus having the light scanning unit can be reduced. In addition, even though a reflection mirror is disposed outside the housing, the reflection mirror is not damaged such that printing quality is not degraded by exposure defect.

Although a few embodiments of the present general inventive concept have been shown and described, it will be appreciated by those skilled in the art that changes may be made in these embodiments without departing from the principles and spirit of the general inventive concept, the scope of which is defined in the appended claims and their equivalents.

What is claimed is:

1. A light scanning unit, comprising:
a housing in which a transparent window is formed;
a light scanning portion disposed inside the housing to scan light to an outside of the housing through the transparent window; and
a reflection mirror disposed outside the housing to reflect the scanned light to an object to be exposed.

2. The light scanning unit of claim 1, wherein the reflection mirror comprises:
a transparent board layer that extends along a main scanning direction of the scanned light; and
a reflection layer coated on a rear surface of the board layer to reflect the scanned light, and the scanned light is transmitted through the board layer to be reflected by the reflection layer and emitted toward the object to be exposed.

3. The light scanning unit of claim 1, wherein the reflection mirror comprises:
a board layer that extends along a main scanning direction of the scanned light;
a reflection layer coated on a front surface of the board layer so that the scanned light is not transmitted to the board layer and is reflected toward the object to be exposed; and
a transparent shield that covers an entire surface of the reflection layer so as to protect the reflection layer.

4. The light scanning unit of claim 1, further comprising:
a frame that is attachable to and removable from the housing to form an internal space that is isolated from the outside when the frame is attached to the housing,
wherein the reflection mirror is installed in the internal space formed by the frame.

5. A light scanning unit usable in an electrophotographic image forming apparatus, comprising:
a housing having an opening;
a light source disposed in the housing to emit light;
an optical deflector disposed in the housing to deflect the emitted light through the opening; and
a reflection mirror disposed outside the housing to reflect the deflected light passing through the opening toward a photosensitive medium.

6. The light scanning unit of claim 5, further comprising:
a frame connected to the opening in the housing and having a second opening through which the reflection mirror reflects the deflected light to the photosensitive medium.

7. The light scanning unit of claim 5, wherein the reflection mirror comprises a plurality of layers including at least one reflective layer to reflect the deflected light.

8. The light scanning unit of claim 7, wherein the at least one reflective layer comprises a coating of SiO₂ disposed on a rigid surface.

9. The light scanning unit of claim 5, wherein the reflection mirror comprises:
a transparent board layer disposed adjacent to the opening; and
a reflection layer disposed at a rear surface of the board layer to reflect the deflected light to the photosensitive medium.

10. The light scanning unit of claim 5, wherein the reflection mirror comprises:
a reflection layer disposed adjacent to the opening to reflect the deflected light to the photosensitive medium; and
a board layer disposed at a rear surface of the reflection layer.

11. The light scanning unit of claim 10, wherein the reflection mirror further comprises:
a shield disposed at a front surface of the reflection layer to protect the reflection layer.

12. The light scanning unit of claim 5, wherein the photosensitive medium comprises a photosensitive drum, and the opening and the reflection mirror extends along a main scanning direction that is parallel to an axis about which the photosensitive drum is rotatable.

13. An electrophotographic image forming apparatus, comprising:
a case;
a photosensitive medium disposed in the case on which an electrostatic latent image is formed; and
a light scanning unit disposed in the case to emit light to form the electrostatic latent image, the light scanning unit including:
a housing having an opening,
a light source disposed in the housing to emit light,
an optical deflector disposed in the housing to deflect the emitted light through the opening along a predetermined plane, and
a reflection mirror disposed on the case to receive light that passes through the opening of the light scanning unit and to reflect the received light toward the photosensitive medium.

14. An electrophotographic image forming apparatus, comprising:
a photosensitive drum having an outer circumference on which an electrostatic image is formed; and
a light scanning unit to scan light that corresponds to image information to the photosensitive drum, the light scanning unit including:
a housing in which a transparent window is formed,
a light scanning portion disposed inside the housing to scan light to outside of the housing through the transparent window, and
a reflection mirror disposed outside the housing to reflect the scanned light to be directed to the photosensitive drum.

15. The electrophotographic image forming apparatus of claim 14, wherein the reflection mirror comprises:
a transparent board layer that extends along a main scanning direction of the scanned light; and
a reflection layer coated on a rear surface of the board layer to reflect the scanned light, and the scanned light is transmitted through the board layer to be reflected by the reflection layer toward the photosensitive drum.

16. The electrophotographic image forming apparatus of claim 14, wherein the reflection mirror comprises:
a board layer that extends along a main scanning direction of the scanned light;
a reflection layer coated on a front surface of the board layer so that the scanned light is not transmitted through the board layer and is reflected toward the photosensitive drum by the reflection layer; and
a transparent shield that covers an entire surface of the reflection layer so as to protect the reflection layer.

17. The electrophotographic image forming apparatus of claim 14, further comprising:
a frame that is attachable to and removable from the housing to form an internal space isolated from the outside when the frame is attached to the housing,
wherein the reflection mirror is installed in the internal space formed by the frame.
